(19) United States
(12) Patent Application Publication
(10) Pub. No.: US 2024/0402392 A1
(43) Pub. Date: Dec. 5, 2024

(54) ANTI-REFLECTIVE STRUCTURING OF OPTICAL ELEMENTS THAT INCLUDE A METASURFACE

(71) Applicant: NILT Switzerland GmbH, Horgen (CH)

(72) Inventors: Yuriy Elesin, Copenhagen (DK); Lars Hagedorn Frandsen, Tårnby (DK); Villads Egede Johansen, Copenhagen (DK); Ulrich Quaade, Bagsvaerd (DK); Brian Bilenberg, Ølstykke (DK)

(21) Appl. No.: 18/699,816

(22) PCT Filed: Oct. 11, 2022
(86) PCT No.: PCT/EP2022/078206

§ 371 Date: Apr. 9, 2024

Related U.S. Application Data
(60) Provisional application No. 63/255,128, filed on Oct. 13, 2021.

(51) Int. Cl. G02B 1/11; G02B 1/00

(52) U.S. Cl. CPC G02B 1/11; G02B 1/002

(57) ABSTRACT

The present disclosure describes anti-reflective structuring of optical elements that include a metasurface. In some implementations, the anti-reflective structuring includes applying one or more anti-reflective coatings over a surface of the metasurface. In some implementations, the anti-reflective structuring includes modifying the shape of the meta-atoms or providing textured features on the meta-atoms so as to reduce reflections.

### FIELD OF THE DISCLOSURE

The present disclosure relates to anti-reflective structuring of optical elements that include a metasurface.

### BACKGROUND

Advanced optical elements may include a metasurface, which refers to a surface with distributed small structures (e.g., meta-atoms) arranged to interact with light in a particular manner. For example, a metasurface, which also may be referred to as a metastructure, can be a surface with a distributed array of nanostructures. The nanostructures may, individually or collectively, interact with light waves. For example, the nanostructures or other meta-atoms may change a local amplitude, a local phase, or both, of an incoming light wave.

When a ray of light passes, for example, into a metasurface, the light passes from one medium (e.g., air) to another (e.g., the metasurface), and some portion of the light may be reflected at the interface between the two media. Unfortunately, such reflections can adversely impact the performance of the optical element. Reducing or eliminating such reflections, however, presents challenges because the metasurface is not flat or smooth, but instead is structured as a result of the presence of the meta-atoms. Further, the meta-atoms typically have dimensions smaller than the operating wavelength and, thus, simply adding conventional anti-reflective layers would be expected adversely to alter the intended optical performance of the meta-atoms.

### SUMMARY

The present disclosure describes anti-reflective (AR) structuring of optical elements that include a metasurface. In some implementations, the AR structuring includes applying one or more anti-reflective coatings (ARCs) over a surface of the metasurface. In some implementations, the AR structuring includes modifying the shape of the meta-atoms or providing textured features on the meta-atoms so as to reduce reflections.

For example, in some implementations, an apparatus includes an optical element that includes a metasurface. A first anti-reflective coating is disposed on at least part of the metasurface.

Some implementations include one or more of the following features. For example, the metasurface can be structured. In some instances, the metasurface includes meta-atoms disposed on a substrate, and the first anti-reflective coating is disposed on the meta-atoms. In some cases, the first anti-reflective coating is disposed on top and sidewall surfaces of the meta-atoms. In some cases, material of the first anti-reflective coating is also disposed on a surface of the substrate facing the meta-atoms. In some instances, a second anti-reflective coating is present on a surface of the substrate facing the meta-atoms, wherein a composition of the second anti-reflective coating differs from a composition of the first anti-reflective coating. In some implementations, the first anti-reflective coating extends beyond edges of the meta-atoms.

In some implementations, a second anti-reflective coating is present on the first anti-reflective coating, wherein a composition of the second anti-reflective coating differs from a composition of the first anti-reflective coating. The first anti-reflective coating can have, for example, an index of refraction greater than an index of refraction of the second anti-reflective coating.

In some implementations, the metasurface includes meta-atoms disposed on a substrate, and the meta-atoms and the substrate are composed of silicon. The first anti-reflective coating, which may be composed of silicon, can be disposed on the meta-atoms and on a surface of the substrate facing the meta-atoms.

In some implementations, the metasurface includes meta-atoms disposed on a substrate, and the meta-atoms are composed of a material different from the substrate. The first anti-reflective coating may be disposed on the meta-atoms, and a second anti-reflective coating can be present on a surface of the substrate facing the meta-atoms. A composition of the second anti-reflective coating may differ from a composition of the first anti-reflective coating. For example, in some instances, the meta-atoms are composed of silicon, the first anti-reflective coating is composed of silicon nitride, the substrate is composed of glass, and the second anti-reflective coating is composed of magnesium fluoride.

In some implementations, the metasurface includes meta-atoms disposed on an etch stop layer, and the first anti-reflective coating is disposed on the meta-atoms. In some instances, the etch stop layer is disposed on a crystalline silicon substrate, and the meta-atoms are composed of amorphous silicon. In some instances, at least one of the first anti-reflective coating or the etch stop layer is composed of silicon nitride. In some implementations, the etch stop layer is composed of an anti-reflective coating material.

The disclosure also describes an apparatus that includes an optical element that includes a metasurface, wherein the metasurface includes meta-atoms having a shape to reduce optical reflections. For example, in some implementations, the meta-atoms have a truncated cone or pyramid shape. In some instances, an anti-reflective coating is disposed on the metasurface. In some cases, the anti-reflective coating may have a non-uniform thickness.

The disclosure also describes an apparatus that includes an optical element that includes a metasurface including meta-atoms. Textured anti-reflective features are present on the meta-atoms. In some implementations, the textured anti-reflective features are composed of a material different from the meta-atoms, whereas in some implementations, the textured anti-reflective features are composed of the same material as the meta-atoms. In some cases, the textured anti-reflective features are imprinted onto the meta-atoms.

The details of one or more implementations are set forth in the accompanying drawings and the description below. Other aspects, features and advantages will be apparent from the following detailed description, the accompanying drawings, and the claims.

### BRIEF DESCRIPTION OF THE DRAWINGS

FIG. 1 is a flowchart illustrating an example of a method of fabricating a metasurface that includes an anti-reflective coating (ARC) on its surface.

FIGS. 2A, 2B and 2C illustrate examples of multiple ARCs on a metasurface.

FIG. 3 is a flowchart illustrating an example of a method of fabricating a metasurface that includes multiple ARCs on its surface.

FIG. 4 illustrates examples of an ARC on meta-atoms formed on a substrate composed of a material different from the meta-atoms.

FIG. 5 illustrates examples of an ARC on meta-atoms formed on a substrate composed of the same material as the meta-atoms.

FIGS. 6, 7, 8, 9 and 10 illustrate examples of metasurfaces having an ARC on their surface.

FIG. 11 shows an example of a structure including multiple ARCs on a metasurface.

FIGS. 12A through 12H illustrate a sequence of fabrication steps for manufacturing the structure of FIG. 11.

FIG. 13 illustrates an example of an ARC on a metasurface supported by a silicon substrate.

FIGS. 14A through 14D illustrate a sequence of fabrication steps for manufacturing the structure of FIG. 13.

FIG. 15 shows an example of an encapsulated metastructure.

FIG. 16 show an example of a metastructure in which the shape of the meta-atoms is modified to help reduce reflections.

FIGS. 17 and 18 show examples of the metastructure of FIG. 14 further including an ARC.

FIGS. 19 and 20 show examples of a metastructure that includes textured anti-reflective features to help reduce reflections.

### DETAILED DESCRIPTION

When meta-atoms (e.g., nanostructures) of a metasurface are in a particular arrangement, the metasurface may act as an optical element such as a lens, lens array, beam splitter, diffuser, polarizer, bandpass filter, or other optical element. The meta-atoms may be arranged, in some cases, in a pattern so that the metastructure functions, for example, as a lens, grating coupler or other optical element. In other instances, the meta-atoms need not be arranged in a pattern, and the metasurface can function, for example, as a fanout grating, diffuser or other optical element. In some implementations, the metasurfaces may perform other functions, including polarization control, negative refractive index transmission, beam deflection, vortex generation, polarization conversion, optical filtering, and plasmonic optical functions.

The present disclosure describes anti-reflective (AR) structuring of optical elements that include a metasurface. In some instances, the AR structuring includes applying one or more anti-reflective coatings (ARCs) over a surface of the metasurface. In some instances, the AR structuring includes modifying the shape of the meta-atoms or providing textured features on the meta-atoms so as to reduce reflections.

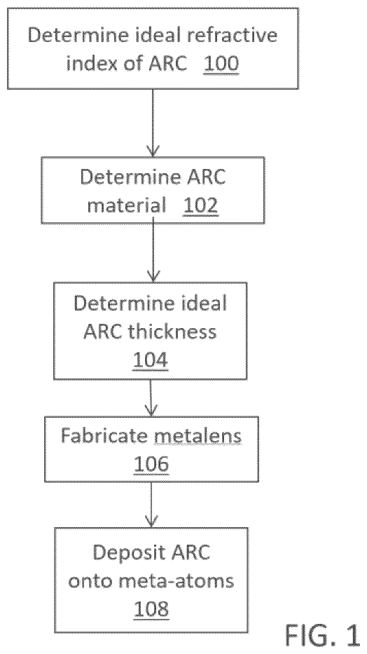

As described in greater detail below, the AR structuring can include applying one or more ARCs on the metasurface. In general, the index of refraction of the ARC applied to the metasurface should have a value that falls between the index of refraction of the material of the metasurface to which the ARC is applied and the index of refraction of the surrounding medium (e.g., air). FIG. 1 is a flowchart illustrating a method of fabricating a metasurface that includes an ARC on the top surface of the meta-atoms. As indicated by 100, an ideal refractive index of the ARC is determined. For example, in some implementations, the ideal refractive index of the ARC (n_{ARC(i)}) is established using the following equation:

$${n}_{ARC ( i )} = \sqrt{{n}_{1} \times {n}_{AIR}}$$

where n₁ is the refractive index of the meta-atoms, and n_{AIR} is the refractive index of the surrounding medium, which in this example is air. Next, as indicated by 102, the material for the ARC is determined, for example, by looking up suitable materials for the ARC. Next, as indicated by 104, an ideal thickness for the ARC is determined. The ideal thickness (t_{ARC}) can be established, for example, using the following equation:

$${t}_{ARC} = \frac{λ}{4 \times {n}_{ARC ( a )}}$$

where n_{ARC(a)} is the refractive index of the actual ARC material. Then, as indicated by 106, the metalens or other metastructure is fabricated, and as indicated by 108, the ARC is deposited onto the metastructure (e.g., onto the meta-atoms).

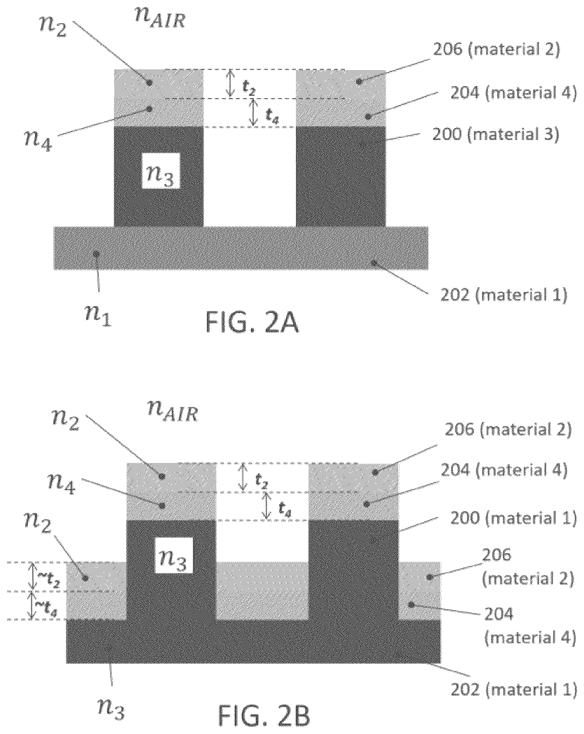

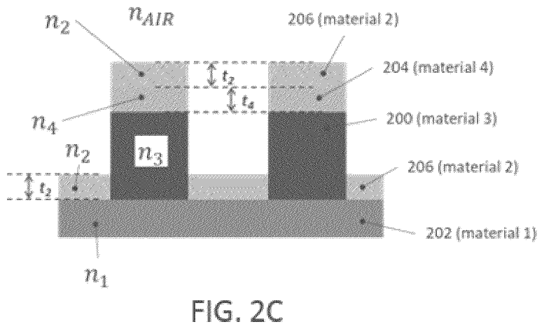

A similar process can be used for situations in which multiple different ARCs are provided one over the other, as illustrated in FIG. 2A, which shows meta-atoms 200 on a substrate 202. The meta-atoms 200 are composed of a material 3 having an index of refraction n₃, and the substrate 202 is composed of a material 1 having an index of refraction n₁. In the illustrated example, the material 1 of the substrate 202 is different from the material 3 of the meta-atoms 200. Further, in the illustrated example, the substrate has a lower refractive index than the meta-atoms and the AR coating. As shown in FIG. 2A, a first ARC 204 is applied on the top of the meta-atoms 200, and a second ARC 206 is applied over the first ARC 204. The first ARC 204 is composed of a material 4 having an index of refraction n₄, and the second ARC 206 is composed of a material 2 having an index of refraction n₂.

In general, it is desirable that the interface between the substrate and the areas on the top side of the substrate (i.e., adjacent the meta-atoms) transition from a high refractive index to a lower refractive index. One reason the implementation of FIG. 2A can be beneficial when the substrate and meta-atoms are composed of different materials is that fewer reflections may result at the interfaces.

The structure of FIG. 2A can be achieved, for example, by performing a sequence of fabrication steps that include depositing the material 3 for the meta-atoms 200 onto the substrate 202, depositing the material 4 for the first ARC 204 onto the top of the material 3 for the meta-atoms 200, depositing the material 2 for the second ARC 206 on the material 4 for the first ARC 204, and etching through the layers for the ARCs and the meta-atoms to form meta-atoms 200 having first and second ARCs 204, 206 on their top surfaces. The etching can be continued so that none of the ARC materials remains on the upper surface of the substrate 202.

In some implementations, as shown in FIG. 2B, the first and second ARCs 204, 206 are applied not only on the top of the meta-atoms 200, but also on the surface of the substrate 202: that is, on the areas between the meta-atoms. Here as well, the second ARC 206 (composed of material 2) can be applied over the first ARC 204 (composed of material 4). Such an arrangement may be particularly beneficial for implementations in which the meta-atoms 200 and substrate 202 are composed of the same material (e.g., amorphous silicon). Nevertheless, in some implementations, as shown in FIG. 2C, the second ARC 206 (composed of material 2) also may be applied on the surface of the substrate 202 even when the meta-atoms 200 and substrate 202 are composed of different materials (e.g., where the meta-atoms 200 are composed of a material 3 having an index of refraction n₃, and the substrate 202 is composed of a material 1 having an index of refraction n₁). Such an arrangement can be useful, for example, where the material indices satisfy the following relationships: n₃>n₄>n₁→n₂>nₐᵢᵣ.

The structure of FIG. 2C can be achieved, for example, by performing a sequence of fabrication steps that include depositing the material 3 for the meta-atoms 200 onto the substrate 202, depositing the material 4 for the first ARC 204 onto the top of the material 3 for the meta-atoms 200, etching through the layers for the first ARC and the meta-atoms to form meta-atoms 200 having the first ARC 204 on their top surfaces (but none of the material 4 for the first ARC on the upper surface of the substrate 202), and depositing the material 2 for the second ARC 206 on the first ARC 204 and on the upper surface of the substrate 202.

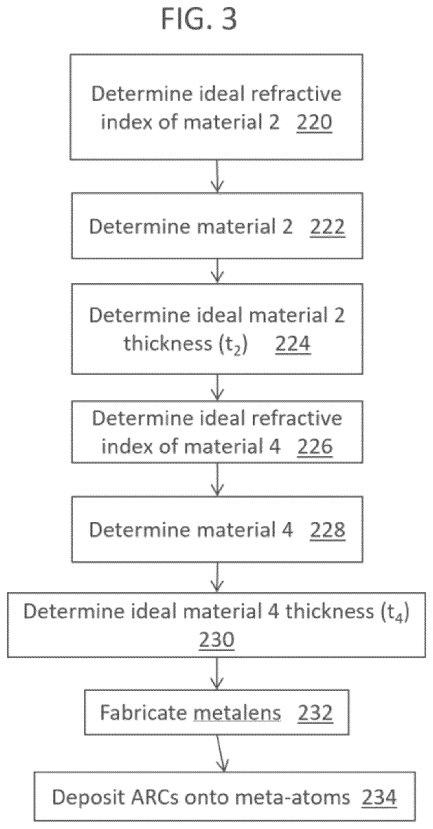

FIG. 3 is a flowchart illustrating a method of fabricating a metasurface (e.g., a metalens) that includes the two ARCs 204, 206. As indicated by 220, an ideal refractive index of the ARC 206 is determined. For example, the ideal refractive index n₂₍ᵢ₎ of the ARC 206 can be established using the following equation:

$${n}_{2 ( i )} = \sqrt{{n}_{1} \times {n}_{AIR}}$$

Next, as indicated by 222, the material for the ARC 206 is determined, for example, by looking up suitable materials. Then, as indicated by 224, an ideal thickness (t₂) for the ARC 206 is determined. The ideal thickness (t₂) can be established, for example, using the following equation:

$${t}_{2} = \frac{λ}{4 \times {n}_{2 ( a )}}$$

where n₂₍ₐ₎ is the refractive index of the actual material 2 for the ARC 206. Further, as indicated by 226, an ideal refractive index of the ARC 204 is determined. For example, the ideal refractive index n₄₍ᵢ₎ of the ARC 204 can be established using the following equation:

$${n}_{4 ( i )} = \sqrt{{n}_{2} \times {n}_{3}}$$

Next, as indicated by 228, the material for the ARC 204 is determined, for example, by looking up suitable materials. Then, as indicated by 230, an ideal thickness (t₄) for the ARC 204 is determined. The ideal thickness (t₄) can be established, for example, using the following equation:

$${t}_{4} = \frac{λ}{4 \times {n}_{4 ( a )}}$$

where n₄₍ₐ₎ is the refractive index of the actual material 4 for the ARC 204. Then, as indicated by 232, the metalens or other metastructure is fabricated, and as indicated by 234, the ARCs 206, 204 are deposited onto the metastructure.

Although the ideal thicknesses of the AR materials on the top of the meta-atoms may be determined by the equations above, the actual thicknesses may differ. Further, in some instances, the thicknesses of the AR materials on the top surface of the substrate may differ from the ideal thicknesses discussed above. For example, in some instances, the thicknesses of the AR materials on the top surface of the substrate may be significantly less than the ideal thicknesses discussed above.

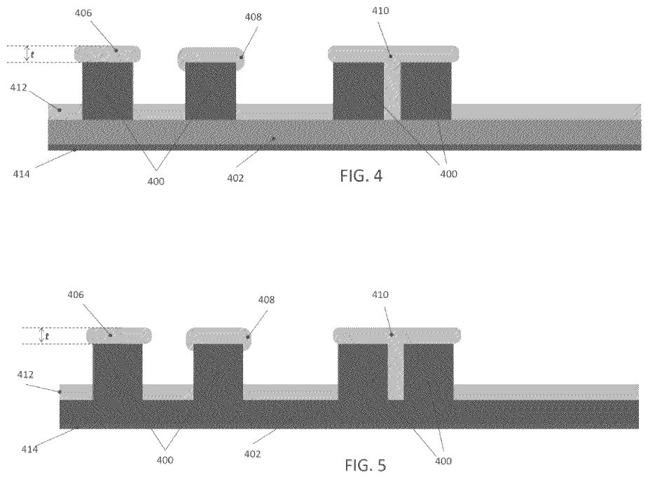

By appropriate selection of the materials for the substrate and meta-atoms, the design of the optical element can be optimized, for example, for an operating wavelength in the near ultra-violet (UV) part of the electromagnetic spectrum, the visible part of the spectrum, or the infra-red (IR) part of the spectrum. In some implementations, as shown in FIG. 4, the meta-atoms 400 are composed of material different from that of the substrate 402. For example, in some instances, the metasurface can be composed of silicon meta-atoms on a glass substrate. For operation in the visible part of the spectrum, the meta-atoms can be composed, for example, of titanium dioxide. In some implementations, as shown in FIG. 5, the meta-atoms 400 and the substrate 402 are composed of the same material (e.g., amorphous silicon). Implementing both the substrate 402 and the meta-atoms 400 in silicon can be advantageous, for example, because processing of silicon is generally well-understood. On the other hand, the relatively high refractive index of silicon can result in significant reflections that should be reduced or eliminated.

As illustrated in FIGS. 4 and 5, an ARC 406 may be present so as to cover the top of the meta-atoms 400 and to help reduce reflections. In some cases, the ARC may have an overhang 408 that extends beyond the edge(s) of the meta-atom. In some instances, a contiguous portion 410 of the ARC may cover two or more meta-atoms 400. An example of the material for the ARC 406 is silicon nitride (e.g., SiNₓ or Si₃N₄), which has an index of refraction between that of Si and air.

An ARC 412 of the same or different material may be present on exposed portions of the substrate 402 (i.e., on the side facing the meta-atoms 400). In some cases (e.g., where the substrate 402 is composed of glass), the ARC 412 can be composed, for example, of magnesium fluoride (MgF₂), which has an index of refraction between that of glass and air. On the other hand, where both the meta-atoms 400 and the substrate 402 are composed of silicon, the ARC 412 can be composed, for example, of Si₃N₄.

Further, in some implementations, another ARC 414 may be provided on the substantially, flat (i.e., unstructured) backside of the substrate 402. The ARC 414 may be composed of a single layer or of multiple layers, which may differ from one another. Providing an ARC 414 of multiple different AR layers can be advantageous, for example, to reduce reflections over a wider range of wavelengths and/or incident angles.

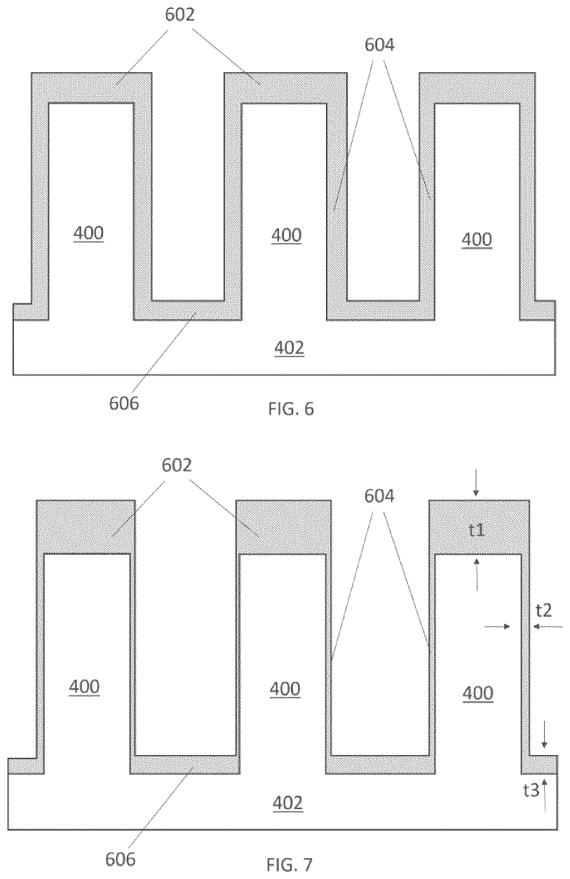

Depending on the implementation, one or more ARCs may be applied on the top surfaces of the meta-atoms, on the side surfaces of the meta-atoms, and/or on the substrate surface facing the meta-atoms. FIGS. 6 through 10 illustrate examples of various implementations. In particular, FIG. 6 shows an example in which a first ARC 602 is applied on the top surfaces of the meta-atoms 400, a second ARC 604 is applied on the side surfaces of the meta-atoms 400, and a third ARC 606 is applied on the surface of the substrate 402 that faces the meta-atoms. The respective compositions of the ARCs 602, 604, 606 may be the same or differ from one another. For example, in some cases, all three ARCs 602, 604, 606 may have the same composition (e.g., SiNₓ) and may be applied at the same time. In other cases, the ARCs 602, 604 may have a first composition, whereas the ARC 606 may have a second, different composition. Further, in some implementations, as shown in the example of FIG. 7, the thicknesses t1, t2, t3 of the first, second and third ARCs 602, 604, 606 may differ from one another. For example, the thickness t2 of the ARC 604 along the sidewalls of the meta-atoms 400 may be significantly less than the thicknesses t1, t3 of the ARCs 602, 606 on the top of the meta-atoms 400 and on the surface of the substrate 402 facing the meta-atoms.

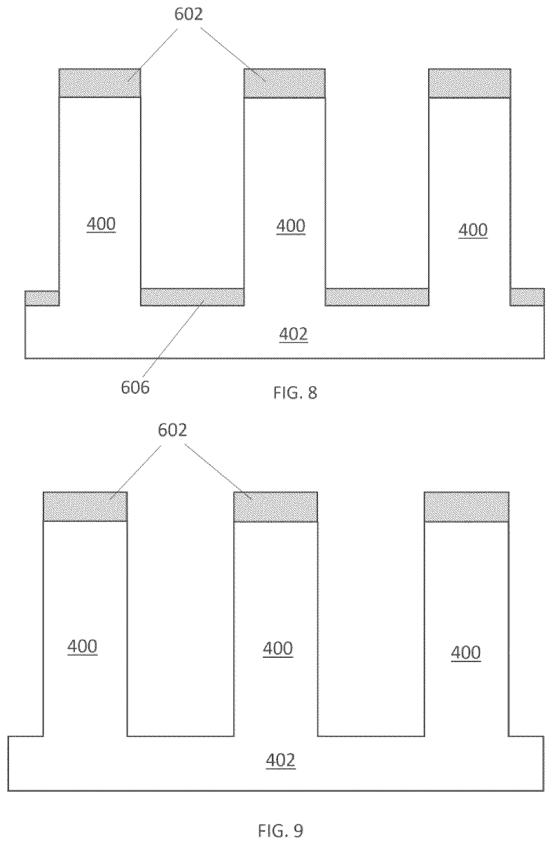

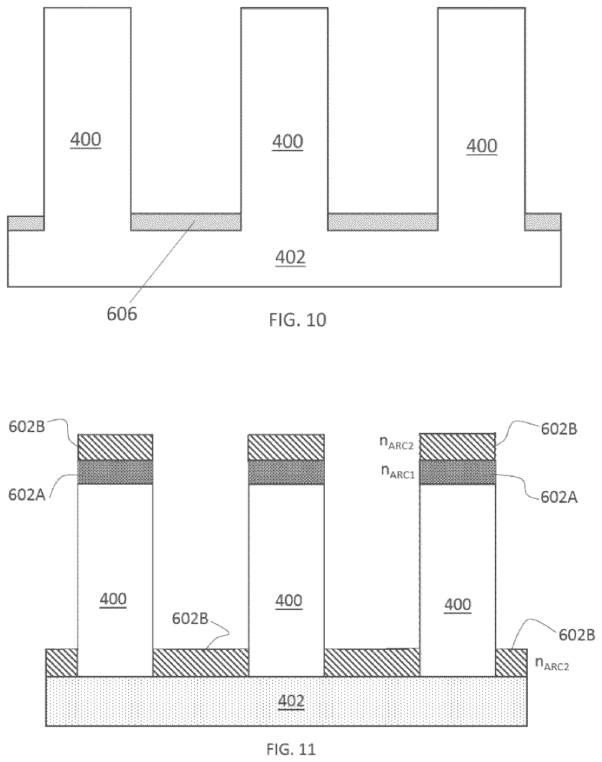

FIG. 8 illustrates another example in which a first ARC 602 is present on the top surfaces of the meta-atoms 400, and another ARC 606 is present on the surface of the substrate 402 that faces the meta-atoms. In this example, the sidewalls of the meta-atoms 400 remain substantially exposed (i.e., not covered by an ARC). In some implementations, an ARC may be present only on the top surfaces of the meta-atoms 400 (see FIG. 9) or only on the surface of the substrate 402 that faces the meta-atoms 400 (see FIG. 10).

FIG. 11 illustrates another example in which a first ARC 602A is present on the top of the meta-atoms 400, and a second ARC 602B is present on the first ARC 602A. In a particular implementation, the substrate 402 is composed of glass (e.g., SiO₂ having an index of refraction n_{SiO2} of about 1.51), and the meta-atoms are composed of amorphous silicon having an index of refraction n_{aSi} of about 3.52. The compositions of the first and second ARCs 602A, 602B can be chosen such that their respective indices of refraction n_{ARC1}, n_{ARC2} satisfy the following criteria: n_{aSi}>n_{ARC1}>n_{SiO2}>n_{ARC2}. For example, in some cases, the first ARC 602A is composed of Si₃N₄ (having an index of refraction of about 1.96), and the second ARC 602B is composed of MgF₂ (having an index of refraction of about 1.34).

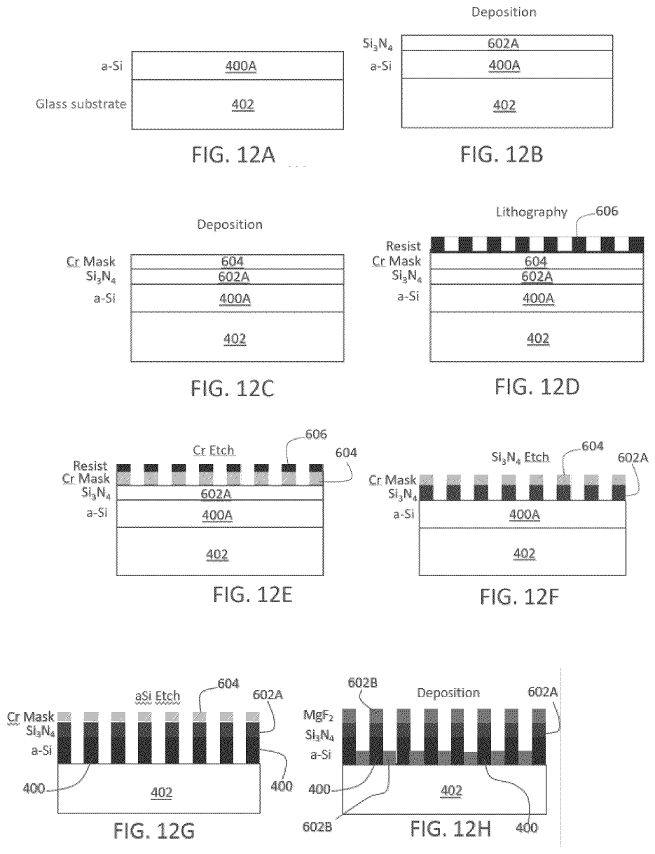

FIGS. 12A through 12H illustrate an example sequence of fabrication processes for manufacturing the structure of FIG. 11. As shown in FIG. 12A, a layer of amorphous silicon (a-Si) 400A is provided on a glass substrate 402. Next, as indicated by FIG. 12B, a layer 602A of Si₃N₄ is deposited onto the a-Si layer 400A. As explained below, the Si₃N₄ layer 602A subsequently can be patterned and can serve as the first ARC. As shown in FIG. 12C, a metal (e.g., chromium (Cr)) layer 604 is deposited on the Si₃N₄ layer 602A, and as indicated by FIG. 12D, a nanoimprint lithography resist layer 606 is formed on the Cr layer 604. Then, as indicated by FIG. 12E, a first etch can be performed, using the resist layer 606 as an etch mask, to etch selectively through the Cr layer 604. Also, as indicated by FIG. 12F, the remaining resist layer 606 can be removed, and a second etch can be performed, using the Cr layer 604 as an etch mask, to etch selectively through the Si₃N₄ layer 602A. Next, as indicated by FIG. 12G, a third etch can be performed to etch selectively through the a-Si layer 400A to form the meta-atoms 400. Then, as shown in FIG. 12H, a layer 602B of MgF₂ can be deposited selectively onto the top of the Si₃N₄ ARC layer 602A and onto the exposed portions of the surface of the substrate 402 that faces the meta-atoms 400. The MgF₂ layer 602B serves as a second ARC. In some implementations, one or more ARCs also may be provided on the substantially flat backside of the substrate 402.

Various techniques can be used to apply the ARCs. Examples of techniques that can be used include low pressure chemical vapor deposition (LPCVD), plasma enhanced chemical vapor deposition (PECVD), atomic layer deposition (ALD), sputter coating, spray coating, or pulsed laser deposition (PLD). Other techniques may be used as well.

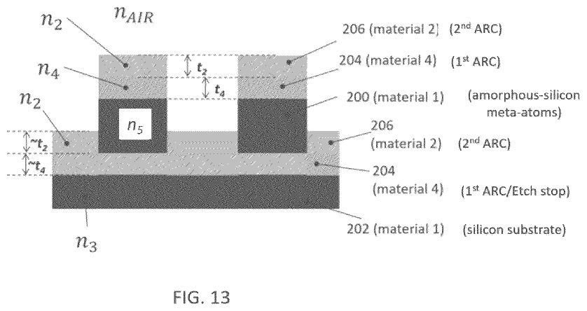

Some implementations include, instead of a glass substrate, a silicon substrate, which can be transparent for shortwave infra-red wavelengths (e.g., 1380 nm-1550 nm). Silicon substrates can, in some instances, provide advantages over glass substrates. For example, silicon substrates are typically allowed in CMOS foundries, whereas glass substrates sometimes are not. Further, due to the mechanical properties (e.g., low wafer bow) and optical properties (e.g., opaque at deep ultra-violate (DUV) wavelengths), silicon substrates can be fully compatible with DUV lithography processes. In contrast, optical lithography (DUV) of glass substrates may requires a relatively complex process flow that utilizes bonding. Further, all-silicon meta optical elements (MOEs) may be integrated monolithically with CMOS electronics. In situations where a silicon substrate is used, it can be helpful to provide an etch-stop layer to reduce lag-effects (i.e., etching of small gaps less than larger gaps). FIG. 13 illustrates an example in which a portion of the ARC 204 (material 4) is present below the meta-atoms 200 (material 1) and serves as an etch-stop layer. In the illustrated example, the substrate is composed of silicon (e.g., crystalline silicon), the meta-atoms are composed of amorphous silicon (a-silicon), and the etch-stop layer is composed of a dielectric material (e.g., Si₃N₄) which also can serve as an anti-reflective coating. In some instances, the etch stop layer and the first ARC on top of the meta-atom pillars are composed of the same material (e.g., Si₃N₄). In other instances, they may be composed of materials different from one another.

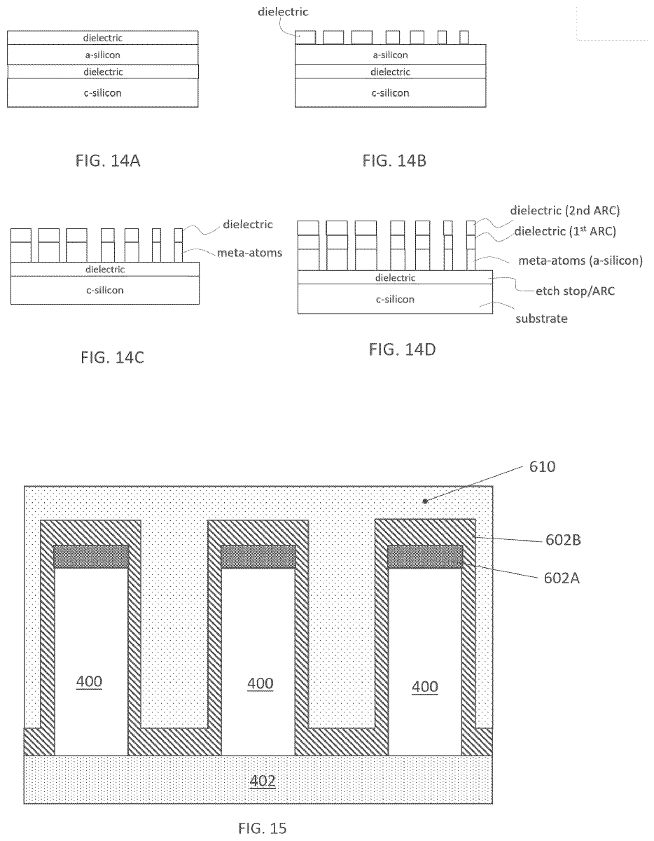

FIGS. 14A through 14D illustrate an example method of manufacturing the structure of FIG. 13. As indicated by FIG. 14A, a first dielectric layer (e.g., Si₃N₄) is provided, for example by deposition, on a crystalline silicon (c-silicon) substrate, an amorphous silicon layer is provided, for example, by deposition, on the first dielectric layer, and a second dielectric layer (e.g., Si₃N₄) is provided, for example by deposition, on the amorphous silicon layer. Next, as indicated by FIG. 14B, the second dielectric layer (which provides the first ARC on top of the meta-atom pillars) is patterned using, for example, one or more of electron beam lithography, nanoimprint lithography, or reactive ion etching. Then, as indicated by FIG. 14C, the pattern is transferred, for example by reactive ion etching, to the amorphous silicon layer to form the meta-atoms. In this fabrication process, the lower dielectric layer can serve as an etch stop layer, which, in some instances, can result in more efficient pattern transfer (e.g., as part of a mass fabrication process). As indicated by FIG. 14D, a dielectric material for the second ARC then can be deposited onto the first ARC that is top of the meta-atom pillars, for example, by sputtering.

In some implementations, as shown in FIG. 15, an encapsulation 610 can be provided over the metasurface. The encapsulation 610 may cover the meta-atoms 400 as well as the ARCs 602A, 602B on the front-side of the metasurface, and may help provide protection, for example, from moisture and other elements, and may help reduce wear and tear. In situations where an encapsulation is to be provided, the material for the ARC 602B should be selected by factoring in that the index of refraction of the surrounding medium (i.e., the material for the encapsulation 610) may be different from that of air.

Depending on the application, an optical element including a metasurface as described in the examples above may be configured such that light at the operating wavelength is incident on the front side of the metasurface (i.e., the side of the metasurface having the structured surface) or on the backside.

In some implementations, instead of, or in addition to, applying one or more ARCs over a surface of the metasurface, the AR structuring includes modifying the shape of the meta-atoms or providing textured features on the meta-atoms so as to reduce reflections.

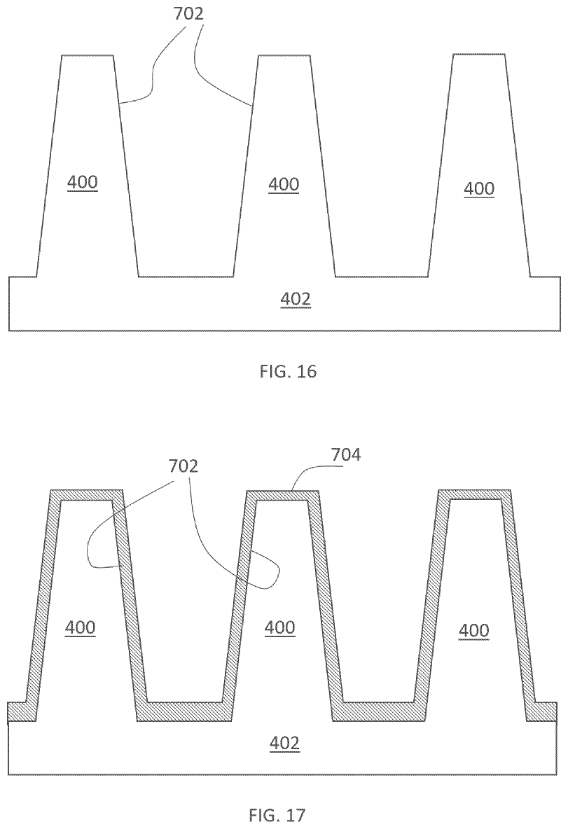

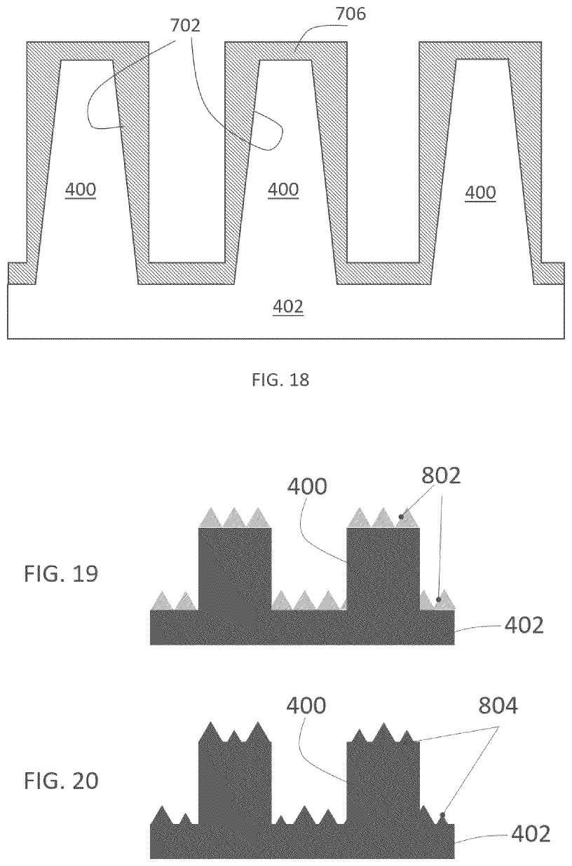

FIG. 16 illustrates an example in which the shape of the meta-atoms 400 is modified to help reduce reflections. In this example, the sidewalls 702 of the meta-atoms 400 are tapered (i.e., slanted) rather than substantially vertical. That is, the meta-atoms can have a truncated cone or pyramid shape, rather than being shaped, for example, as cylindrical pillars. In some implementations, other modifications to the shape of the meta-atoms can be used to help reduce unwanted reflections. In some instances, an ARC can be provided on the surface of the tapered meta-atoms to help reduce reflections even further. For example, as shown in FIG. 17, a highly conformal or uniform ARC 704 can be achieved. In other instances, as shown in the example of FIG. 18, an ARC 706 on the surface of the tapered meta-atoms 400 may not be highly conformal or uniform. That is, the thickness of the ARC 706 may vary.

FIGS. 19 and 20 illustrate examples in which textured AR features 802, 804 are provided on the meta-atoms to help reduce unwanted reflections. In FIG. 17, the textured AR features 802 are composed of a material different from that of the meta-atoms 400. The AR features 802 can be formed, for example, by depositing a coating over the meta-atoms 400 and then imprinting the coating to form the textured features 802. Alternatively, the coating may be deposited and then roughened (e.g., by etching) so as to form the textured AR features 802. In FIG. 18, the textured AR features 804 are composed of the same material different as the meta-atoms 400. The AR features 804 can be formed, for example, by direct imprinting. For example, nanoimprint lithography can be used to form the meta-atoms 400 and the textured AR features 804 during the same imprinting process. Alternatively, the surface of the meta-atoms 400 can be roughened (e.g., by etching) so as to form the textured AR features 804.

Various modifications will be readily apparent from the foregoing detailed description and the drawings. In some instances, features described above in connection with different implementations may be combined in the same implementation. Accordingly, other implementations also are within the scope of the claims.

What is claimed is:

1. An apparatus comprising:
an optical element that includes a metasurface; and
a first anti-reflective coating disposed on at least part of the metasurface.

2. The apparatus of claim 1 wherein the metasurface is structured.

3. The apparatus of claim 1 wherein the metasurface includes meta-atoms disposed on a substrate, the first anti-reflective coating being disposed on the meta-atoms.

4. The apparatus of claim 3 wherein the first anti-reflective coating is disposed on top and sidewall surfaces of the meta-atoms.

5. The apparatus of claim 3 wherein material of the first anti-reflective coating is also disposed on a surface of the substrate facing the meta-atoms.

6. The apparatus of claim 3 further including a second anti-reflective coating on a surface of the substrate facing the meta-atoms, wherein a composition of the second anti-reflective coating differs from a composition of the first anti-reflective coating.

7. The apparatus of claim 3 wherein the first anti-reflective coating extends beyond edges of the meta-atoms.

8. The apparatus of claim 3 further including a second anti-reflective coating on the first anti-reflective coating, wherein a composition of the second anti-reflective coating differs from a composition of the first anti-reflective coating.

9. The apparatus of claim 8 wherein the first anti-reflective coating has an index of refraction greater than an index of refraction of the second anti-reflective coating.

10. The apparatus of claim 1 wherein:
the metasurface includes meta-atoms disposed on a substrate,
the meta-atoms and the substrate are composed of silicon,
the first anti-reflective coating is disposed on the meta-atoms and on a surface of the substrate facing the meta-atoms, and
the first anti-reflective coating is composed of silicon nitride.

11. The apparatus of claim 1 wherein:
the metasurface includes meta-atoms disposed on a substrate,
the meta-atoms are composed of a material different from the substrate,
the first anti-reflective coating is disposed on the meta-atoms, and
a second anti-reflective coating is on a surface of the substrate facing the meta-atoms, wherein a composition of the second anti-reflective coating differs from a composition of the first anti-reflective coating.

12. The apparatus of claim 11 wherein:
the meta-atoms are composed of silicon, and the first anti-reflective coating is composed of silicon nitride, and
the substrate is composed of glass, and the second anti-reflective coating is composed of magnesium fluoride.

13. The apparatus of claim 1 wherein:
the metasurface includes meta-atoms disposed on an etch stop layer, and
the first anti-reflective coating is disposed on the meta-atoms.

14. The apparatus of claim 13 wherein the etch stop layer is disposed on a crystalline silicon substrate, and the meta-atoms are composed of amorphous silicon.

15. The apparatus of claim 14 wherein at least one of the first anti-reflective coating or the etch stop layer is composed of silicon nitride.

16. The apparatus of claim 14 wherein the etch stop layer is composed of an anti-reflective coating material.

17. An apparatus comprising:
an optical element that includes a metasurface,
wherein the metasurface includes meta-atoms having a shape to reduce optical reflections.

18. The apparatus of claim 17 wherein the meta-atoms have a truncated cone or pyramid shape.

19. The apparatus of claim 17 further including an anti-reflective coating disposed on the metasurface.

20. The apparatus of claim 19 wherein the anti-reflective coating has non-uniform thickness.

21. An apparatus comprising:
an optical element that includes a metasurface, the metasurface including meta-atoms;
textured anti-reflective features on the meta-atoms.

22. The apparatus of claim 21 wherein the textured anti-reflective features are composed of a material different from the meta-atoms.

23. The apparatus of claim 21 wherein the textured anti-reflective features are composed of a same material as the meta-atoms.

24. The apparatus of claim 21 wherein the textured anti-reflective features are imprinted onto the meta-atoms.
